(19) United States
(12) Patent Application Publication
(10) Pub. No.: US 2014/0100953 A1
(43) Pub. Date: Apr. 10, 2014

(54) Delivering Mobile Messages to Wireless Mobile Devices Based on Current Delivery Preference and Network Capabilities to Improve User Experience

(71) Applicant: Cezary Kolodziej, Deer Park, IL (US)

(72) Inventor: Cezary Kolodziej, Deer Park, IL (US)

(21) Appl. No.: 14/044,999

(22) Filed: Oct. 3, 2013

Related U.S. Application Data
(60) Provisional application No. 61/710,701, filed on Oct. 6, 2012.

(51) Int. Cl. H04W 4/12; G06Q 30/02

(52) U.S. Cl. CPC H04W 4/12; G06Q 30/0267
USPC 705/14.53; 455/466

(57) ABSTRACT

A mobile messaging server of in an example interacts with a wireless communication data network, a device database, a campaign content database, a device preference database, and operator's network requirement database to deliver one or more of images, bar codes, videos and/or simple plain text via a pushed mobile message to a mobile device identified by a mobile number for mobile messaging communication, for example, to meet a desirable, beneficial, good, and/or best possible user experience, for example, based on mobile device capabilities and operator's network requirements at current point in time based on real time capabilities detection.

### DESCRIPTION OF THE DRAWINGS

Features of exemplary implementations of the invention will become apparent from the description, the claims, and the accompanying drawings in which:

FIG. 1 is a representation of an implementation of an apparatus that comprises a wireless communication data network, a device database, a campaign content database, a device preference database, an operator's network requirement, a mobile messaging server that is in charge of sending rich content within a mobile message to a mobile device identified by a mobile number for mobile messaging communication.

FIG. 2 is a representation of an implementation of the apparatus of FIG. 1 and illustrates relationships between data in the device database, the mobile device and a data in the device preference database.

FIG. 3 is a representation of the campaign content database of an implementation of the apparatus of FIG. 1 where one of multiple versions of rich content of a mobile campaign is stored.

FIG. 4 is a representation of the operator's network requirements database of an implementation of the apparatus of FIG. 1.

FIG. 5 is a representation of logic flow of an implementation of the apparatus of FIG. 1 and illustrates the mobile messaging server controlling the content delivered to the mobile device based on its capabilities, operator's network requirements at which the mobile device operates, and the mobile device's latest preference of communication interface.

### DETAILED DESCRIPTION

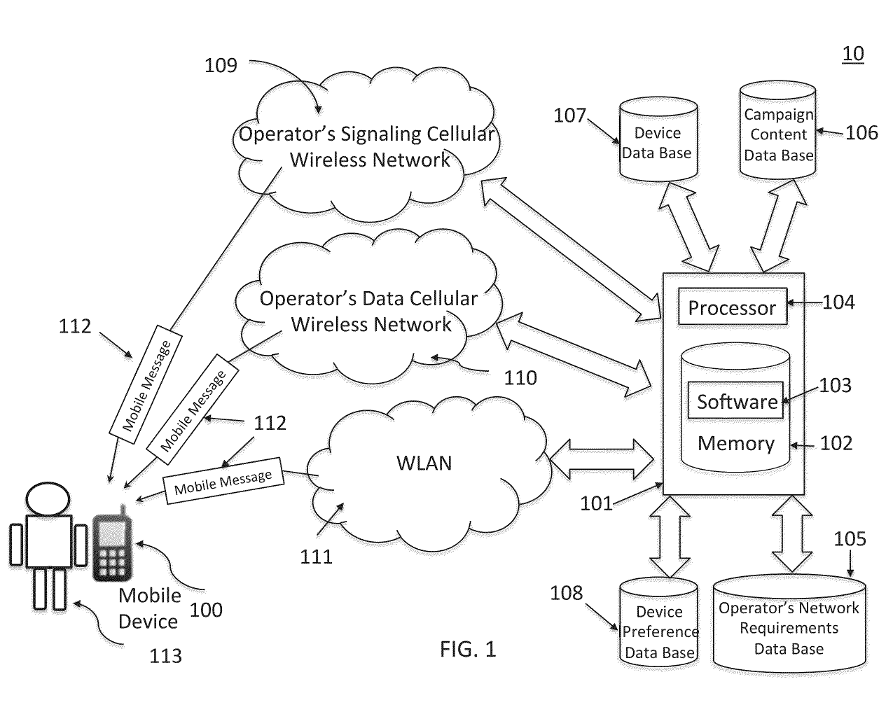

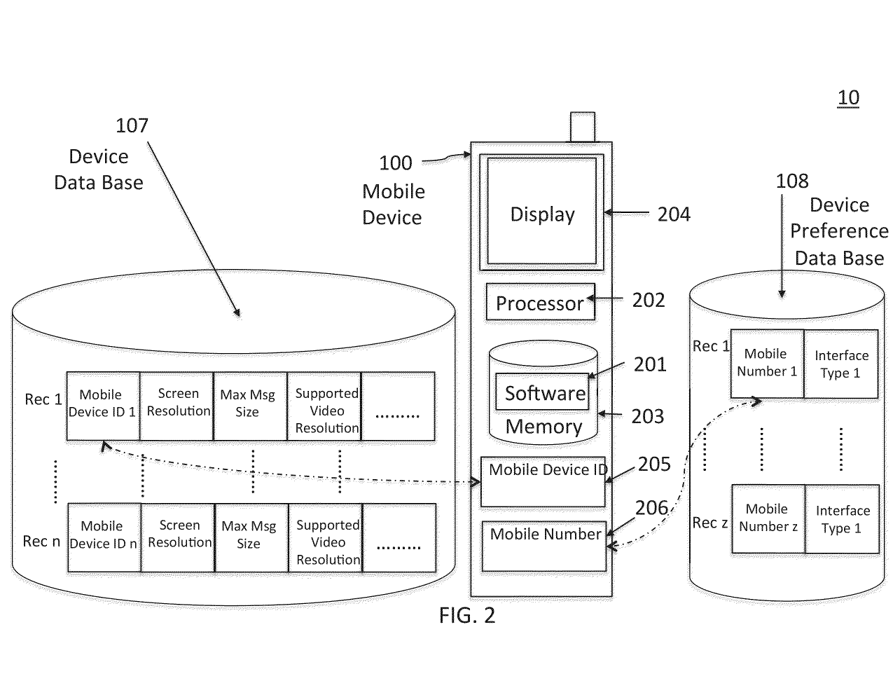

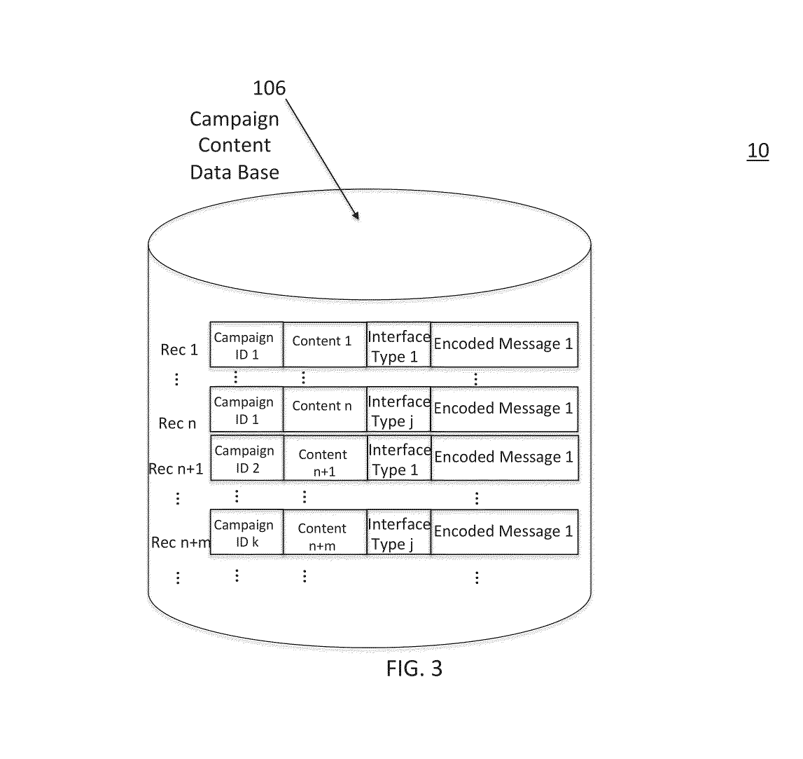

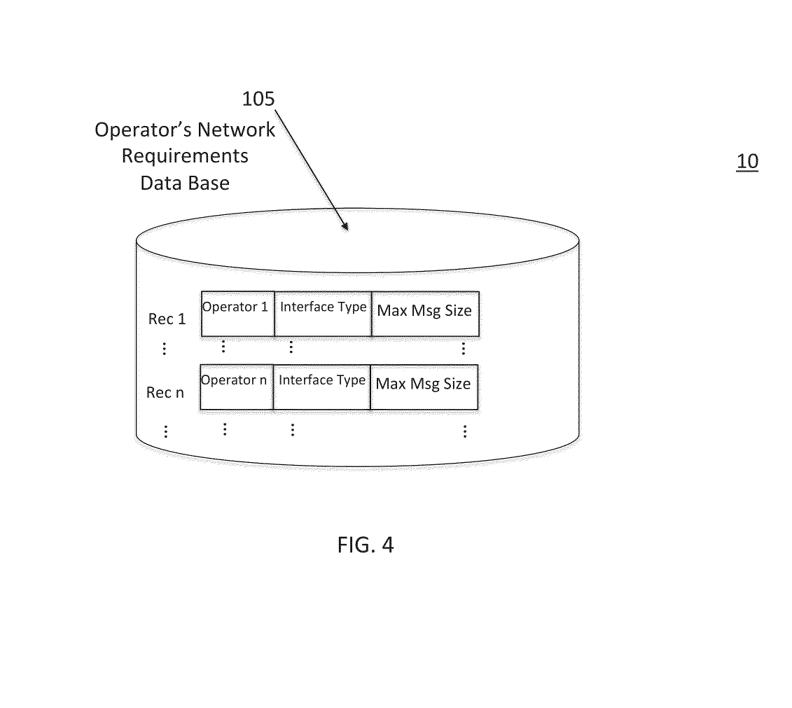

Turning to FIG. 1, an implementation of an apparatus (10) comprises a mobile messaging server (101) tasked to send one or more mobile message (112) to one or more mobile devices (100). The mobile device (100) in an example comprises one or more of a mobile device, mobile phone, electronic tablet, wireless modem, personal digital assistant (pda), laptop, smartphone, and/or computing device. The mobile message (112) might in an example comprise rich content that comprises one or more of images, bar codes, videos and simple plain text, for example, all stored in a campaign content database (106) (FIG. 3). An abundance of mobile devices (100) in an example are available with different screen sizes, aspect ratios, resolutions, and software versions for rendering images and video playing, delivering a single version of rich content to any one or more of a plurality of mobile devices (100) in an example causes rich content to be blurry, stretched, and/or squeezed on a set and/or majority of screens of the mobile devices (100). An undesirable effect of blurring, stretching, and/or squeezing images and/or videos in an example comprises difficulty for the user (113) to read and/or watch the rich content. The difficulty in an example comprises bad user experience for the user (113). The messaging server (101) in an example delivers the mobile message (112) in a way and/or to allow the rich content of the delivered mobile message (112) to meet the capabilities (e.g., screen size, resolution, aspect ratio, capable of playing video, capable of rendering image, maximum message size handled by the mobile device, etc.) of the mobile device (100), for example, stored in a device database (107) (FIG. 2) The meeting of the capabilities of the mobile device (100) in an example conforms with an operator's network requirements in which the mobile device (100) operates, stored in an operator's network requirements database (105) (FIG. 4) and employs a most recent and/or latest preferred delivery communication channel of the mobile device (100), for example, stored in a device preference database (108) (FIG. 2).

Referring to FIG. 1, the user (113) in an example comprises one or more of a human, a woman, a man, an adult, a child, a customer, a player, a trainee, an intern, a student, a graduate, an elderly person, and/or a professional. Mobile messaging communication in an example comprises delivery and/or receipt of one or more mobile messages (112). Mobile messaging communication in an example comprises one or more of Short Message Service (SMS), Multimedia Messaging Service (MMS), Wireless Application Protocol-Push (WAP-Push) and/or in-application software (in-app) notification pushed/delivered to the mobile device (100) via a signaling cellular network (109), a data cellular network (110), and/or the local wireless communication data network (111). For example, the user (113) may be a customer of the signaling cellular network (109), the data cellular network (110), and/or the local wireless communication data network (111). The user (113) as the customer in an example employs the mobile device (100) for mobile communication and/or mobile messaging communication.

Referring to FIG. 1, the signaling cellular network (109) in an example comprises any signaling cellular network deployed by any mobile wireless operator for call set-up and short message services (SMS) such as GSM (Global System for Mobile Communications) and CDMA (Code Division Multiple Access). The data cellular network (110) in an example comprises any data cellular network deployed by any mobile wireless for providing internet data services on wireless data network devices such as 1x(1xRTT) (CDMA2000), 1xEV-DO (Evolution-Data Optimized), 3G (third generation of mobile telecommunications technology), and/or 4G (fourth generation of mobile telecommunications technology).

Referring to FIG. 1, a mobile messaging server (101) comprises software (103) stored in memory (102) of the mobile messaging server (101) and executed by processor (104) of the mobile messaging server (101). The mobile messaging server (101) in an example sends a desirable and/or most possible matching/or tuned mobile message (112) to the mobile device (110) based on mobile device's capabilities (e.g., stored in the device database (107)) and/or operator's network capabilities (e.g., stored in operator's network requirements database (105)) and/or employing current device preferred communication channel (e.g., stored in device preference database (108)).

Referring to FIG. 2, the mobile device (100) in an example comprises software (201) stored in its memory (203) and executed by its processor (202). The mobile device (100) has specific set of capabilities used for support and rendering rich content on its display (204). All capabilities of the mobile device (100) in an example are part of a mobile device profile uniquely identified by device ID (205) of the mobile device (100). The device ID (205) in an example comprises a mobile device ID and/or a media device ID. The mobile device (100) in an example operates within an operator wireless network (reference numeral?) uniquely identified by a mobile number (206) of the mobile device (100). The device database (107) in an example comprises one or multiple records of capabilities of a plurality of mobile devices (100) uniquely identified by respective mobile device IDs (205). Mobile device (100) operating within an operator wireless network (reference numeral?) can receive a mobile message (112) via signaling cellular network (109), data cellular network (110) and/or the local wireless communication data network (111). The mobile messaging server (101) in an example makes a determination of which communication channel (109, 110, 111) to use based on device preferences, for example, current network coverage (e.g., mobile device (100) might not have physical connection to data cellular network (100) but is connected to the local wireless communication data network (111)), network capabilities (e.g., mobile device (100) is connected to 3G and not to 4G data cellular network), and/or other real-time data stored in the device preference database (108) identified by the mobile number (205). The device preference database (108) in an example stores the preference data of the mobile device (100). The device ID (205) of the mobile device (100) in an example identifies the device preference database (108).

Referring to FIG. 3, a campaign content database (106) is an example comprises a number of records of rich content to be used to deliver targeted advertisements (ads) or promotions to a mobile device (100).

A targeted ad in a mobile message (112) in an example sent to the mobile device (100) in an example may promote a sale event at the store or small business and/or an additional discount on a purchase, for example, of $50 or more.

Campaign content in the campaign content database (106) in an example comprises one or more instances of images, videos, graphics and text of different sizes, resolutions, aspect ratio that perfectly renders on different screen sizes, resolutions, message sizes of different mobile devices (100) participating in the same advertising or promotional campaign. Contents in an example are encoded in one or many formats supported by different mobile devices (100) and different delivery channels available on different cellular network operators (e.g., Verizon, Orange, T-Mobile, etc.).

Referring to FIG. 4, an operator's network requirements database (105) is an example comprises a number of records of mobile messaging delivery capabilities on specific cellular network operators. For example, one operator supports delivery of mobile messaging up to 100 KB of data while other supports delivery of much larger mobile messages up to 1 MB of data. Another operator might support only SMS but not MMS messages while other might support in-application software (in-app) notifications only.

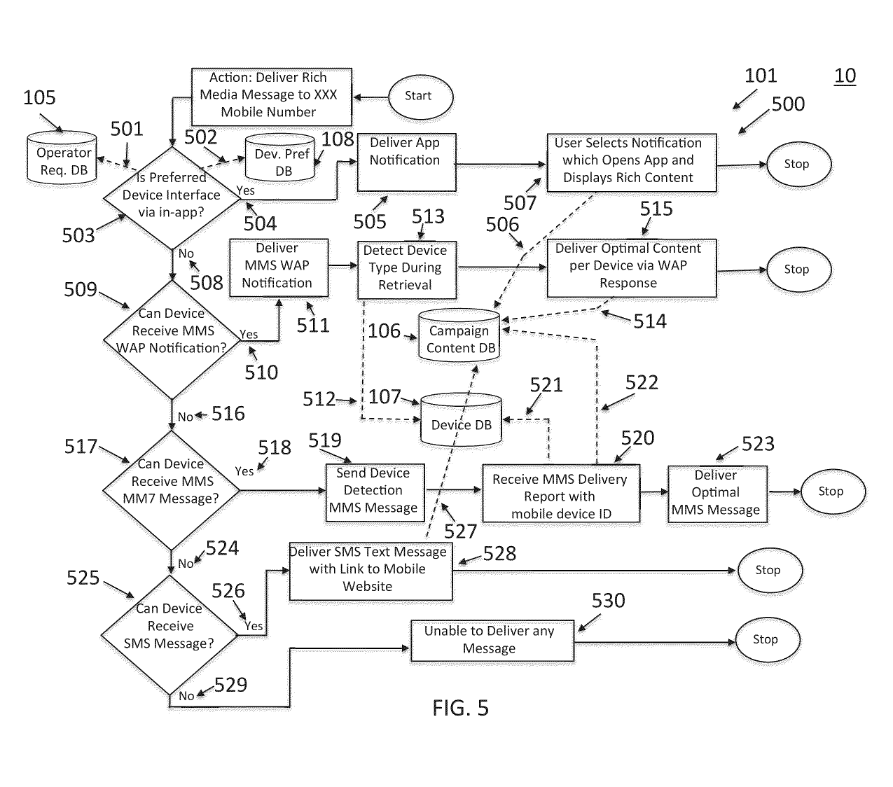

An illustrative description of an exemplary operation of an implementation of the apparatus 10 is presented in FIG. 5. Referring to FIG. 1, FIG. 2 and FIG. 5, in exemplary logic flow 500, a mobile messaging server (101) it tasked (Start) with delivering a mobile message (112) to a mobile device (100) identified by a mobile number (206). The mobile message (112) in an example comprises one or more of images, bar codes, videos and simple plain text. For example, the mobile message (112) comprises rich media content that comprises one or more of images, bar codes, videos and simple plain text. The mobile message (112) might contain one or more rich media contents and the mobile device (100) and/or communication channels (109,110,111) in an example utilize some or all available capabilities thereof to deliver the mobile message (112).

The mobile message (112) might comprise one or more targeted advertisements (ads) to be delivered to a mobile device (100) based on one or more of campaign contents defined by one or more of a marketer, promoter and/or owner of the campaign content and/or historical usage patterns of a mobile device (100) by user (113).

For example, the mobile device (100) and/or communication channels (109,110,111) in an example deliver the mobile message (112) with a desirable, beneficial, good, and/or best possible experience for user (113) who will open and read the mobile message (112) on her mobile device (100) at her current location. The mobile device (100) in an example does not support video content but only images and plain text. As a result in an example the messaging server (101) will deliver alternative content stored in the campaign content database (106) (e.g., Content 1 in FIG. 3) to the mobile device (100). Had video content (e.g., Content 1 for Campaign ID 1 in FIG. 3) been delivered to the mobile device (100) in an example the content would have failed to be played and the user (113) would have been presented with an error message e.g., “file format not supported”, which in an example represents an undesirable, unbeneficial, bad, and/or worst user experience for user (113). In another example, campaign content, Content 1 for Campaign ID 2 (FIG. 3), stored in the campaign content database (106) is image based of resolution 176×144. The screen of mobile device (110) has resolution of 640×960. This is the only resolution stored in campaign content database (106) for Campaign ID 2. When image based campaign content (Content 1) of resolution 176×144 is delivered to the mobile device (100) of 640×960 resolution in an example the content is nearly, effectively, and/or practically unreadable to the user (113), which in an example represents an undesirable, unbeneficial, bad, and/or worst user experience for user (113). In a further example, another content (Content 2) of resolution 640×960 for Campaign ID 2 is also stored in the campaign content database (106). Based on capabilities for Mobile Device ID1 (FIG. 2) and its screen resolution of 640×960, the mobile messaging server (101) will deliver Content 2 and not Content 1 in this case. Content 2 delivered in the mobile message (112) will be of similar and/or the same resolution as the resolution of the mobile device (100) and will practically, effectively, nearly, and/or perfectly match the screen of the mobile device (100). The user (113) will be presented with one or more images that are not blurry nor stretched and perfectly sized to the screen of mobile device (100). This represents a desirable, beneficial, good, and/or best possible user experience. In another example, instead of Content 2, Content 3 of resolution 320×480 for Campaign ID 2 is stored in the campaign content database (106). In this case, for Campaign ID 2, the messaging server (101) will deliver Content 3 of resolution 320×480 and not Content 1 of resolution 176×144 since Content 3 has the same aspect ration as the resolution of the mobile device (100). It will make the campaign content for Campaign ID 2 more readable on mobile device (100) and it will comprise a desirable, beneficial, good, and/or best possible user experience of user (113) if only Content 1 and Content 3 are stored in the campaign content database (106) for Campaign ID 2.

Based on the mobile number (206), the mobile messaging server (101) determines, via interaction (501) with an operator's network requirements database (105), what communication channels a cellular operator's wireless network the mobile device (100) operates within supports for delivering the mobile message (112). Based on currently available communication channels, the mobile messaging server (101) determines, via interaction (502) with a device preference database (108), what is a currently preferred communication channel of the mobile device (100).

If in-app notification is available (503) and preferred (504), the mobile messaging server (101) delivers an app notification (505) to the mobile device (100). Upon delivering the app notification, the user (113) selects notification (506) on her mobile device (110), which opens an app, downloads (507) the content of mobile message (112) from a campaign content database (106) and displays rich content with via a desirable, beneficial, good, and/or best possible user experience, concluding delivery of mobile message (112) to the mobile device (100).

If in-app notification is not available (508), the mobile messaging server (101) determines whether the mobile device (100) can receive MMS WAP Notification (509) via previous interaction with the operator's network requirements database (105) and the device preferred database (108).

If the mobile device (100) can indeed receive (510) MMS WAP Notification, the mobile messaging server sends (511) the MMS WAP Notification via operator's signaling cellular wireless network (109). Upon receiving the MMS WAP Notification, the mobile device (100) attempts to retrieve the mobile message (112), via operator's data cellular wireless network cellular network (110) and reports its mobile device ID (205) in its message retrieval attempt. Based on received mobile device ID (205) and operators network requirements database (105), the messaging server (101) interacts (512) with a device database (107) to determine messaging capabilities (513) of the mobile device (100). Such capabilities comprise, among others, screen resolution, maximum message size, supported video formats (if any), viewable aspect ratio. Based on capabilities data from the device database (107), the messaging server (101) identifies (514) the closest fit between the capabilities of the mobile device (100) and the content version of the mobile message (112) stored in a campaign content database (106). The identified rich content is delivered (515) to the mobile device (100), displayed on the mobile device via its display (204) and presents a desirable, beneficial, good, and/or best possible experience to the user (113), concluding the mobile message (112) delivery to the mobile device (100).

If the mobile device (100) cannot receive MMS WAP Notification (516), the mobile messaging server (101) determines whether the mobile device (100) can receive MMS MM7 Message (517).

If the mobile device (100) can indeed receive MMS MM7 Message (518), the messaging server (101) sends Device Detection MMS Message (519) to the mobile device (100) requesting MMS Delivery Report. The mobile messaging server (101) receives (520) a mobile device ID (205). Based on received mobile device ID (205) and operators network requirements database (105), the messaging server (101) interacts (521) with a device database (107) to determine messaging capabilities of the mobile device (100). Such capabilities comprise, among others, screen resolution, maximum message size, supported video formats (if any), viewable aspect ratio. Based on capabilities data from the device database (107), the messaging server (101) identifies (522) the closest fit between the capabilities of the mobile device (100) and the content version of the mobile message (112) stored in a campaign content database (106). The identified rich content is delivered (523) to the mobile device (100), displayed on the mobile device via its display (204) and presents a desirable, beneficial, good, and/or best possible experience to the user (113), concluding the mobile message (112) delivery to the mobile device (100).

If the mobile device (100) cannot receive MMS MM7 Message (524), the messaging server (101) determines whether the mobile device (100) can receive SMS Message (525).

If the mobile device (100) can indeed receive SMS message (526), the mobile messaging server (101) identifies (527) a match and/or the best fit, text based content version of the mobile massage (112) stored in a campaign content database (106). The identified text based content is delivered (528) to the mobile device (100), displayed on the mobile device via its display (204) and presents a desirable, beneficial, good, and/or best possible experience to the user (113), concluding the mobile message (112) delivery to the mobile device (100).

If the mobile device (100) cannot receive SMS Message (529), the messaging server (101) is unable to deliver (530) any format of mobile message (112) to the mobile device (100), concluding any further mobile message delivery attempts to the mobile device (100).

An implementation of the apparatus (10) comprises an algorithm, procedure, program, process, mechanism, engine, model, coordinator, module, unit, application, software, code, and/or logic. An implementation of the apparatus (10) comprises one or more user-level programs, for example, user interface logic residing in one or more user-level program files.

An implementation of the apparatus (10) comprises a plurality of components such as one or more of electronic components, chemical components, organic components, mechanical components, hardware components, optical components, and/or computer software components. A number of such components may be combined or divided in an implementation of the apparatus (10). One or more components of an implementation of the apparatus (10) and/or one or more parts thereof may comprise one or more of a computing, communication, interactive, and/or imaging device, interface, computer, and/or machine. One or more components of an implementation of the apparatus (10) and/or one or more parts thereof may serve to allow selection, employment, channeling, processing, analysis, communication, and/or transformation of electrical signals and/or between and/or among physical, logical, transitional, transitory, persistent, and/or electrical signals, inputs, outputs, measurements, and/or representations.

A plurality of instances of a particular component may be present in an implementation of the apparatus (10). One or more features described herein in connection with one or more components and/or one or more parts thereof may be applicable and/or extendible analogously to one or more other instances of the particular component and/or other components in an implementation of the apparatus (10). One or more features described herein in connection with one or more components and/or one or more parts thereof may be omitted from or modified in one or more other instances of the particular component and/or other components in an implementation of the apparatus (10). An exemplary technical effect is one or more exemplary and/or desirable functions, approaches, and/or procedures. An exemplary component of an implementation of the apparatus (10) may employ and/or comprise a set and/or series of computer instructions written in or implemented with any of a number of programming languages, as will be appreciated by those skilled in the art.

An implementation of the apparatus (10) may comprise any (e.g., horizontal, oblique, angled, or vertical) orientation, with the description and figures herein illustrating an exemplary orientation of an exemplary implementation of the apparatus (10), for explanatory purposes. One or more components of an implementation of the apparatus (10) and/or one or more parts thereof may occupy a number of locations of the apparatus (10).

An implementation of the apparatus (10) may encompass an article and/or an article of manufacture. The article may comprise one or more computer-readable signal-bearing media. The article may comprise means and/or instructions in the one or more media for one or more exemplary and/or desirable functions, approaches, and/or procedures.

An implementation of the apparatus (10) may employ one or more computer readable signal-bearing media. A computer-readable signal-bearing medium may store software, firmware and/or assembly language for performing one or more portions of an implementation of the apparatus (10). An example of a computer-readable signal bearing medium for an implementation of the apparatus (10) may comprise a memory and/or recordable data storage medium of the mobile device (100), the memory (102), the signaling cellular network (109), the data cellular network (110), and/or the local wireless communication data network (111). A computer-readable signal-bearing medium for an implementation of the apparatus (10) in an example may comprise a device and/or non-transitory recording medium into which data can be located for a length of time and subsequently retrieved. Data in an example may be one or more of located, placed, moved, and/or copied into a non-transitory recording medium as a computer-readable signal bearing medium for an implementation of the apparatus (10). Data in an example may be one or more of located, stored, saved, and/or held until a later time in a non-transitory recording medium as a computer-readable signal bearing medium for an implementation of the apparatus (10). Data in an example may be one or more of retrieved, accessed, obtained, restored, and/or reproduced from a non-transitory recording medium as a computer-readable signal bearing medium for an implementation of the apparatus (10). For example, one or more portions and/or the entirety of the original data can be retrieved from a non-transitory recording medium of an implementation of the apparatus (10). A computer-readable signal-bearing medium for an implementation of the apparatus (10) in an example may comprise one or more of a magnetic, electrical, optical, biological, chemical, and/or atomic data storage medium. For example, an implementation of the computer-readable signal-bearing medium may comprise one or more flash drives, optical discs, memory cards, computer networks, CDs (compact discs), DVDs (digital video discs), hard drives, portable drives, and/or electronic memory. A computer-readable signal-bearing medium in an example may comprise a physical computer medium, computer-readable signal-bearing tangible medium, and/or non-transitory medium.

The steps or operations described herein are examples. There may be variations to these steps or operations without departing from the spirit of the invention. For example, the steps may be performed in a differing order, or steps may be added, deleted, or modified.

Although exemplary implementation of the invention has been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. An apparatus, comprising:
a mobile messaging server that interacts with a wireless communication data network, a device database, a campaign content database, a device preference database, and operator's network requirement database to deliver one or more of images, bar codes, videos and simple plain text via a pushed mobile message to a mobile device identified by a mobile number for mobile messaging communication.

2. The apparatus of claim 1, wherein the mobile messaging server pushes the mobile message to the mobile device identified by the mobile number via one or more of a signaling cellular wireless network, a data cellular wireless network, and/or a local wireless communication data network.

3. The apparatus of claim 2, wherein the mobile messaging server selects any one of the signaling cellular wireless network, the data cellular wireless network, and/or the local wireless communication data network that the mobile messaging server determines to meet a preference of the mobile device;
wherein the mobile messaging server pushes the mobile message to the mobile device identified by the mobile number via the any one of the signaling cellular wireless network, the data cellular wireless network, and/or the local wireless communication data network that the mobile messaging server determines to meet the preference of the mobile device.

4. The apparatus of claim 3, wherein the mobile messaging server determines a mobile device ID of the mobile device via an interface of an in-app notification.

5. The apparatus of claim 3, wherein the mobile messaging server determines a mobile device ID of the mobile device via an MMS WAP notification.

6. The apparatus of claim 5, wherein the mobile messaging server identifies the mobile device ID of the mobile device via an MMS message.

7. The apparatus of claim 1, wherein the mobile messaging server selects a version of campaign content in the campaign content database from a determination that the version of campaign content matches rendering capabilities of the mobile device.

8. The apparatus of claim 7, wherein the mobile messaging server delivers the version of campaign content over mobile messaging to meet a desirable user experience based on capabilities of the mobile device from the device database and operator's network requirements from the operator's network requirement database.

9. An apparatus, comprising:
a mobile messaging server that interacts with a campaign content database to determine one or more targeted advertisements (ads) to be delivered to a mobile device via mobile message based on one or more of:
campaign content defined by one or more of a marketer, promoter and/or owner of the campaign content; and/or
historical usage patterns of a mobile device.

10. The apparatus of claim 9, wherein the mobile messaging server pushes a targeted ad of the one or more targeted ads via employment of one or more of a signaling cellular wireless network, a data cellular wireless network, and/or a local wireless communication data network.

11. A method, comprising the steps of:
employing a database of capabilities of a mobile device in real time; and
delivering mobile messages to the mobile device based on one or more of capabilities of the mobile device and/or historical usage patterns of the mobile device.
